(19) United States
(12) Patent Application Publication
(10) Pub. No.: US 2014/0312024 A1
(43) Pub. Date: Oct. 23, 2014

(54) METHOD FOR PRODUCING STEEL SHEET FOR PRESS MOLDING, AND METHOD AND DEVICE FOR PRODUCING PRESS-MOLDED COMPONENT

(71) Applicants: Tetsuji Egawa, Okazaki-shi (JP); Kazuhisa Maeda, Toyota-shi (JP); Koji Akinaga, Miyoshi-shi (JP); Kiyoshi Nonomura, Nisshin-shi (JP)

(72) Inventors: Tetsuji Egawa, Okazaki-shi (JP); Kazuhisa Maeda, Toyota-shi (JP); Koji Akinaga, Miyoshi-shi (JP); Kiyoshi Nonomura, Nisshin-shi (JP)

(73) Assignee: TOYOTA JIDOSHA KABUSHIKI KAISHA, Toyota-shi, Aichi (JP)

(21) Appl. No.: 14/362,270

(22) PCT Filed: Feb. 14, 2012
(86) PCT No.: PCT/JP2012/053423

§ 371 Date: Jun. 2, 2014

(30) Foreign Application Priority Data
Dec. 9, 2011 (JP) 2011-270183

(51) Int. Cl. B21J 1/06; H05B 3/00

(52) U.S. Cl. CPC B21J 1/06; H05B 3/0004
USPC 219/149

(57) ABSTRACT

[Problem] To provide a method for producing a non-rectangular steel sheet to be heated to the predetermined temperature, a method and apparatus for producing a press-molded article using the non-rectangular steel sheet for press molding that is produced by means of that method for producing the same.

[Solution] The method for producing a steel sheet for press molding according to one embodiment of the invention includes an electrical heating process (STEP-101) for electrically heating a blank (10) of rectangular steel sheet, viewed from the thickness direction of the blank, and a bending process (STEP-102) for deforming the blank (10) from a rectangle to a non-rectangle by applying stress in a horizontal direction to the surfaces (front (10a) and back (10b)) of the blank (10) after the start of electrical heating.

### TECHNICAL FIELD

The present invention relates to a method for producing a steel sheet for press molding, and a method and apparatus for producing a press-molded article.

### BACKGROUND ART

Conventionally, there is a widely employed technique for press molding that the press molding is performed after a blank is heated by electrical heating in order to enhance formability of the blank and the blank is quenched during the press molding in order to produce a high-strength product efficiently.

For example, JP 2008-87001 A discloses the technique of electrically heating the blank before the press molding.

In the conventional art disclosed in JP 2008-87001 A, a sheet workpiece (blank) is electrically heated by using a pair of electrodes separating from each other.

The blank electrically heated in such manner has a rectangular shape. If the blank has a different shape from rectangle (non-rectangle shape), there locally occurs a variation in current density while the electrical heating, and thus the usual electrical heating may fail to uniformly heat the non-rectangular blank.

### CITATION LIST

### Patent Literature

PTL 1: JP 2008-87001 A

### SUMMARY OF INVENTION

### Technical Problem

In the case that a product is produced by the press molding, the shape of the blank, which is previously heated to a predetermined temperature, (hereinafter, “a steel sheet for press molding”) may be advantageously formed in a shape corresponding to the product shape (i.e., non-rectangle), considering the improvement of material yield rate.

However, by means of the conventional art, it is difficult to uniformly heat the non-rectangular blank by electrical heating, whereby the steel sheet for press molding is not formed in the non-rectangular shape and a rectangular blank is generally used as a rectangular steel sheet for press molding.

As a result, when producing the product by press molding, the material yield rate may be low, and therefore, there is a need to provide a technique of obtaining the non-rectangular steel sheet for press molding having the shape corresponding to the product shape, utilizing the method of electrically heating.

The present invention aims to solve above mentioned problems, and in other words, to provide a method for producing a non-rectangular steel sheet that is heated to the predetermined temperature, a method and apparatus for producing a press-molded article using the non-rectangular steel sheet for press molding that is produced by means of that method for producing the same.

### Technical Solutions

The problems to be solved by the present invention are presented above, and the technical solutions are followed below.

The first aspect of the invention includes an electrical heating process for electrically heating a steel blank having a rectangle shape viewed from a thickness direction of the steel blank; and a deforming process for deforming the steel blank from the rectangle into a non-rectangle by applying a stress to the steel blank after the start of electrical heating.

The second aspect of the invention has the feature that, in the deforming process, the stress is applied in a direction perpendicular to the thickness direction of the steel blank to the steel blank after the electrical heating.

The third aspect of the invention has the feature that, in the deforming process, the stress is applied in a direction perpendicular to the thickness direction of the steel blank to the steel blank with clamping and pressing the steel blank by means of cushion members made by materials having adiabaticity.

The forth aspect of the invention further includes a curved portion forming process for forming a curved portion projected toward the thickness direction in the steel blank, which is parallel to a length direction of the steel blank before the electrical heating process.

The fifth aspect of the invention includes an electrical heating process for electrically heating a steel blank having a rectangle shape viewed from a thickness direction of the blank; a deforming process for deforming the steel blank from the rectangle into a non-rectangle by applying a stress to the steel blank after the start of electrical heating; and a press molding process for press molding the steel blank having the non-rectangle shape to which the stress is applied.

The sixth aspect of the invention has the feature that, in the deforming process, the stress is applied in a direction perpendicular to the thickness direction of the steel blank to the steel blank with clamping and pressing the steel blank by means of cushion members made by materials having adiabaticity.

The seventh aspect of the invention further includes a curved portion forming process for forming a curved portion projected toward the thickness direction in the steel blank, which is parallel to a length direction of the steel blank before the electrical heating process.

The eighth aspect of the invention includes an electrical heating apparatus for electrically heating a steel blank having a rectangle shape viewed from a thickness direction of the steel blank; a stress applying device for applying a stress in a direction perpendicular to the thickness direction of the steel blank to the steel blank after the start of electrical heating; and a press molding apparatus for press molding the steel blank having a non-rectangle shape to which the stress is applied by the stress applying apparatus.

### Advantageous Effects of Invention

The present invention provides following effects.

The first aspect of the invention provides a non-rectangular steel sheet for press molding that is heated to the predetermined temperature.

The second aspect of the invention provides a non-rectangular steel sheet for press molding that is heated to the predetermined temperature.

The third aspect of the invention provides a non-rectangular steel sheet for press molding with high quality without wrinkles.

According to the forth aspect of the invention, the blank can be bent by smaller stress. Therefore, the bending apparatus can be simply constructed.

The fifth aspect of the invention provides a press-molded article having uniform thickness.

The sixth aspect of the invention provides a non-rectangular steel sheet for press molding with high quality without wrinkles.

According to the seventh aspect of the invention, the blank can be bent by smaller stress. Therefore, the bending apparatus can be simply constructed.

The eighth aspect of the invention provides a press-molded article having uniform thickness.

### BRIEF DESCRIPTION OF DRAWINGS

FIG. 1 depicts a structure of an electrical heating apparatus for use in a method for producing a steel sheet for press molding according to the present invention, (a) shows a flat view, and (b) shows a side view.

FIG. 2 is a perspective view of the electrical heating apparatus for use in the method for producing the steel sheet.

FIG. 3 depicts a first embodiment of a structure of a bending apparatus according to the invention, (a) shows a flat view, and (b) shows a side view.

FIG. 4 depicts the bending apparatus according to the first embodiment of the method for producing the steel sheet.

FIG. 5 depicts a second embodiment of a structure of a bending apparatus according to the invention, (a) shows a side view, and (b) shows a side view where a blank is held by a clamp.

FIG. 6 shows the method for producing the steel sheet according to the invention.

FIG. 7 shows a flow of the method for producing the steel sheet according to the invention, (a) is a flowchart of a first embodiment of the method for producing the steel sheet according to the invention, and (b) is a flowchart of a second embodiment of the method for producing the steel sheet according to the invention.

FIG. 8 is a schematic view of producing process in the case that the steel sheet has a shape α, (a) shows the first embodiment of the method for producing the steel sheet according to the invention, and (b) shows the conventional method for producing the steel sheet according to the invention.

FIG. 9 is a schematic view of producing process in the case that the steel sheet has a shape β, (a) shows the first embodiment of the method for producing the steel sheet according to the invention, and (b) shows the conventional method for producing the steel sheet according to the invention.

FIG. 10 is a schematic view of producing process in the case that the steel sheet has a shape γ, (a) shows the first embodiment of the method for producing the steel sheet according to the invention, and (b) shows the conventional method for producing the steel sheet according to the invention.

FIG. 11 shows a second embodiment of the method for producing the steel sheet according to the invention, (a) shows an electrical heating process according to the second embodiment of the method for producing the steel sheet according to the invention, (b) shows a bending process according to the second embodiment of the method for producing the steel sheet according to the invention, and (c) shows a steel sheet for press molding produced by the second embodiment of the method for producing the steel sheet according to the invention.

FIG. 12 depicts a structure of a first embodiment of a producing apparatus for press-molded article according to the invention.

FIG. 13 depicts a structure of a press molding apparatus composing the first embodiment of the producing apparatus for press-molded article according to the invention.

FIG. 14 shows a flow of a first embodiment of the method for producing the press-molded article according to the invention.

FIG. 15 shows a flow of a second embodiment of the method for producing the press-molded article according to the invention.

FIG. 16 is a schematic view illustrating features of the press-molded article produced by the first embodiment of the method for producing the press-molded article according to the invention.

FIG. 17 is a schematic view illustrating features of the press-molded article produced by the conventional method for producing the press-molded article according to the invention.

### DESCRIPTION OF EMBODIMENTS

The description of embodiments is described below.

First, a blank used in a method for producing a steel sheet for press molding according to the invention is described.

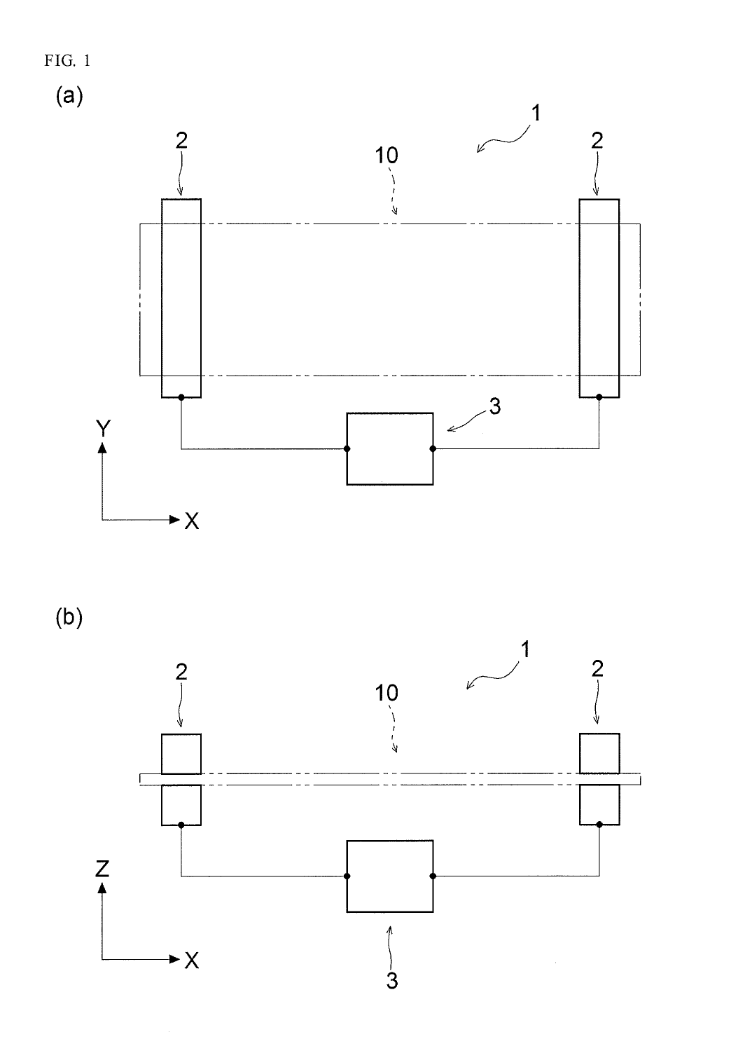

It should be noted that, in the following description, the arrow X shown in FIGS. 1(a) and 1(b) is defined as a length direction of the blank (current direction), and the arrow Y is defined as a width direction of the blank. The arrow Z shown in FIGS. 1(a) and 1(b) is defined as a thickness direction of the blank.

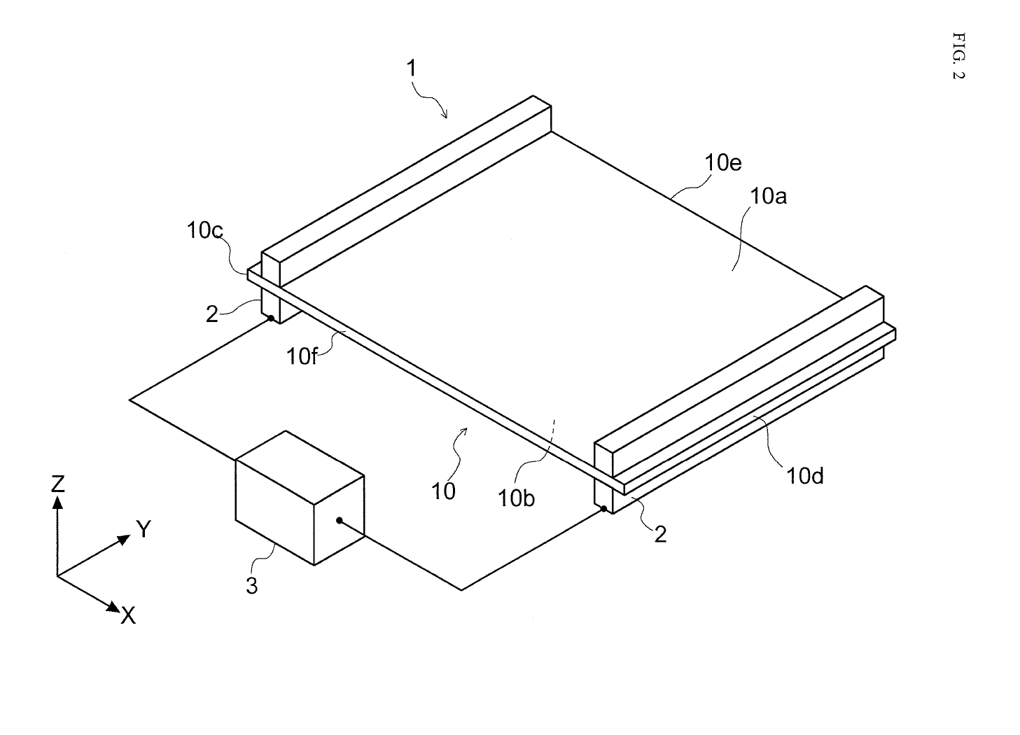

As depicted in FIGS. 1 and 2, the blank 10 used in the method for producing the steel sheet for press molding according to the invention is a rectangular steel blank viewed from the thickness direction (arrow Z direction), and has a front 10a and a back 10b to which electrodes 2 contact so that the electrical heating is performed.

In the both ends of the blank 10 in the length direction (arrow X direction), energized parts 10c and 10d are formed to contact the electrodes 2.

The blank 10 is formed with sides 10e and 10f at both ends of the blank in the width direction (arrow Y direction), and the sides are parallel to the current direction.

In the present embodiment, illustrating a case of using the rectangular blank 10, but the blank used in the method for producing the steel sheet for press molding according to the invention is not necessarily rectangle (i.e., it may not be a perfect rectangle and square).

That is, the term “rectangle” in the description, is the concept that refers not only to completely square or rectangle, but also to substantially rectangle in the case that the portion where to be uniformly heated is rectangle, for example, the shape partially including projection or recess in the other portion than that portion where to be obtained uniform temperature, which will be removed (i.e., the excess portion).

Referring to FIGS. 1 to 5, apparatuses used in the method for producing the steel sheet for press molding according to the invention are described.

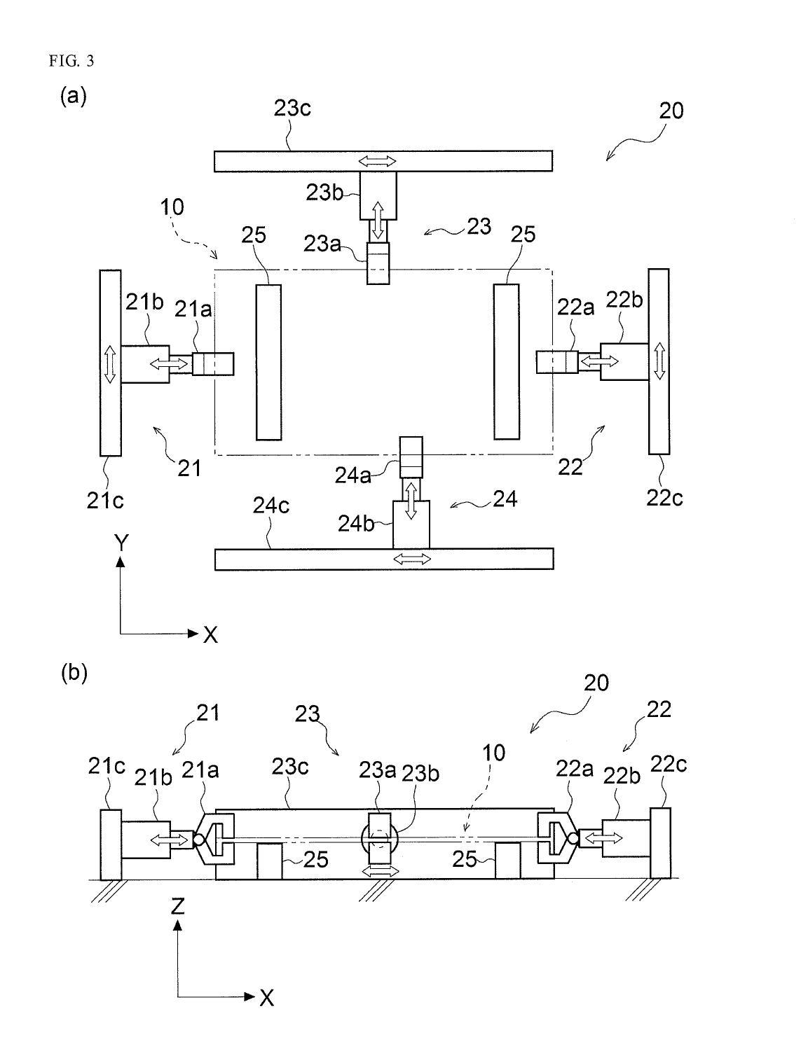

The method for producing the steel sheet for press molding according to the invention can be provided by using an electrical heating apparatus 1 as shown in FIGS. 1 and 2 and a bending apparatus 20 as shown in FIGS. 3-5, both of which are used to work the blank 10.

The electrical heating apparatus used in the method for producing the steel sheet for press molding according to the invention is described below.

As depicted in FIGS. 1 and 2, the electrical heating apparatus 1 is used to electrically heat the blank 10 as a material for press molding, before the press molding process, and the electrical heating apparatus includes the pair of electrodes 2 and a power supply 3.

The electrodes 2 are connected to the energized parts 10c and 10d formed at the both ends of the blank 10 in the length direction (arrow X direction).

The electrodes 2 are connected with the power supply 3, and the power supply 3, the electrodes 2 and the blank 10 make a closed loop circuit.

The power supply 3 applies a predetermined voltage to the electrodes 2, thereby applying a predetermined electric current to the blank 10 in the length direction of the blank 10 (arrow X direction), i.e., the electric heating is operated.

The bending apparatus for use in the method for producing the steel sheet for press molding according to the invention is described below.

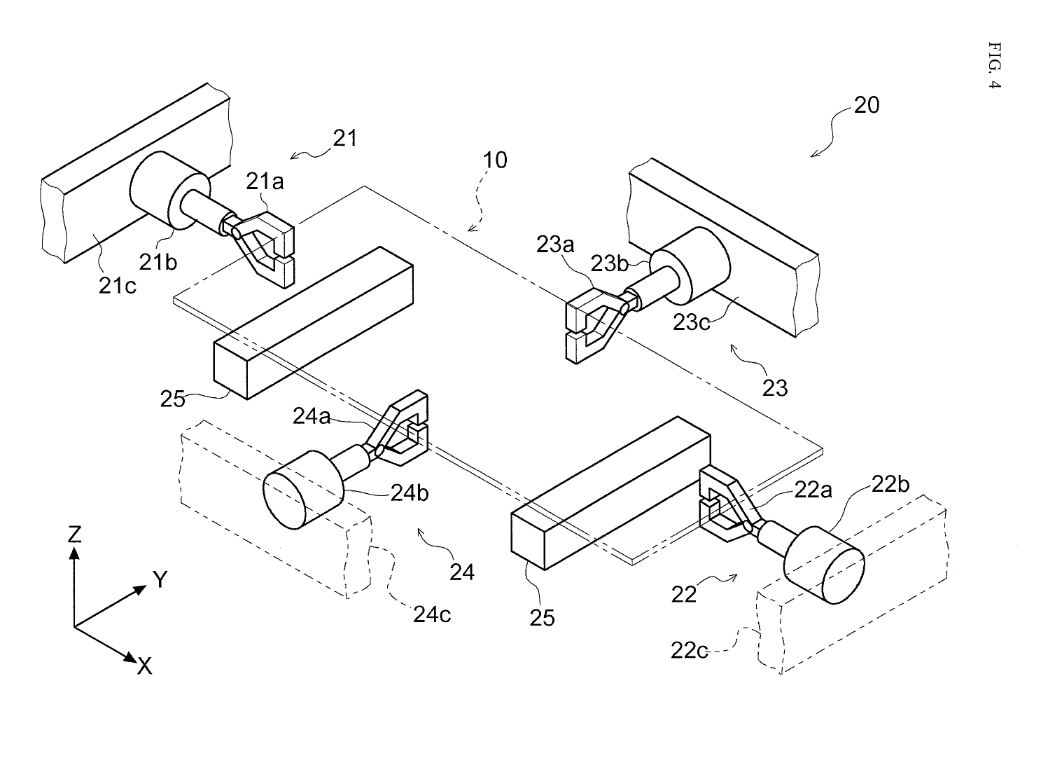

As depicted in FIGS. 3 and 4, a bending apparatus 20 for use in the method for producing the steel sheet for press molding according to the invention applies a stress to the blank 10 in a direction perpendicular to the thickness direction of the blank 10 (arrow Z direction), and bends the blank 10. The bending apparatus includes multiple stress applying devices 21, 22, 23 and 24.

The bending apparatus 20 also includes positioning parts 25 for arranging the blank 10 in a predetermined position and with a predetermined posture.

The blank 10 is arranged on the positioning parts 25 of the bending apparatus 20 is held with the thickness direction being vertical direction, thereby holding the front 10a and the back 10b level.

The peripheries 10c, 10d, 10e and 10f of the blank 10 are arranged in positions corresponding to the stress applying devices 21, 22, 23 and 24, respectively.

It should be noted that the bending apparatus 20 in the embodiment includes four stress applying devices 21, 22, 23 and 24, however, the number of the stress applying devices is not limited, and for example, two or more stress applying devices may be provided in each periphery.

The stress applying device 21 is arranged to face the energized part 10c of the blank 10 that is positioned with the predetermined posture on the positioning parts 25, and includes a clamp 21a for clamping the energized part 10c. The clamp 21a is supported by a shifter 21b, thereby being shiftable in the length direction of the blank 10 (arrow X direction).

Thus, in the situation that the clamp 21a clamps the energized 10c, the shaft of the shifter 21b is contracted, thereby applying a tension in the arrow X direction of the blank 10.

In an alternative embodiment, the clamp 21a holds a pressing part (not shown) and the shaft of the shifter 21b is elongated, and then the pressing part presses the energized part 10c and applies the compressive force in the arrow X direction of the blank 10.

In the stress applying device 21, the shifter 21b is supported by a slider 21c, which makes the blank 10 shiftable in the width direction of the blank 10 (arrow Y direction).

Thus, the holding position for the energized part 10c can be changed.

The stress applying device 22 is arranged to face the energized part 10d of the blank 10 that is positioned with the predetermined posture on the positioning parts 25, and includes a clamp 22a for clamping the energized part 10d. The clamp 22a is supported by a shifter 22b, thereby being shiftable in the length direction of the blank 10 (arrow X direction).

Thus, in the situation that the clamp 22a clamps the energized 10d, the shaft of the shifter 22b is contracted, thereby applying a tension in the arrow X direction of the blank 10.

In an alternative embodiment, the clamp 22a holds a pressing part (not shown) and the shaft of the shifter 22b is elongated, and then the pressing part presses the energized part 10d and applies the compressive force in the arrow X direction of the blank 10.

In the stress applying device 22, the shifter 22b is supported by a slider 22c, which makes the blank 10 shiftable in the width direction of the blank 10 (arrow Y direction).

Thus, the holding position for the energized part 10d can be changed.

The stress applying device 23 is arranged to face the side 10e of the blank 10 that is positioned with the predetermined posture on the positioning parts 25, and includes a clamp 23a for clamping the side 10e. The clamp 23a is supported by a shifter 23b, thereby being shiftable in the width direction of the blank 10 (arrow Y direction).

Thus, in the situation that the clamp 23a clamps the side 10e, the shaft of the shifter 23b is contracted, thereby applying a tension in the arrow Y direction of the blank 10.

In an alternative embodiment, the clamp 23a holds a pressing part (not shown) and the shaft of the shifter 23b is elongated, and then the pressing part presses the side 10e and applies the compressive force in the arrow Y direction of the blank 10.

In the stress applying device 23, the shifter 23b is supported by a slider 23c, which makes the blank 10 shiftable in the length direction of the blank 10 (arrow X direction).

Thus, the holding position for the side 10e can be changed.

The stress applying device 24 is arranged to face the side 10f of the blank 10 that is positioned with the predetermined posture on the positioning parts 25, and includes a clamp 24a for clamping the side 10e. The clamp 24a is supported by a shifter 24b, thereby being shiftable in the width direction of the blank 10 (arrow Y direction).

Thus, in the situation that the clamp 24a clamps the side 10f, the shaft of the shifter 24b is contracted, thereby applying a tension in the arrow Y direction of the blank 10.

In an alternative embodiment, the clamp 24a holds a pressing part (not shown) and the shaft of the shifter 24b is elongated, and then the pressing part presses the side 10f and applies the compressive force in the arrow Y direction of the blank 10.

In the stress applying device 24, the shifter 24b is supported by a slider 24c, which makes the blank 10 shiftable in the length direction of the blank 10 (arrow X direction).

Thus, the holding position for the side 10f can be changed.

As described above, the bending apparatus 20 includes the positioning parts 25 for arranging the blank 10 that has the rectangular shape viewed from the thickness direction, and the stress applying devices 21, 22, 23 and 24 for applying the stress to the blank 10 in the direction perpendicular to the thickness direction.

Due to the structure, a non-rectangular steel sheet for press molding 15 is obtained that is heated to a predetermined temperature.

The bending apparatus 20 in the embodiment deforms the blank 10 by applying the stresses parallel to the length direction (arrow X direction) and parallel to the width direction (arrow Y direction) of the blank 10 using the stress applying devices 21, 22, 23 and 24, however, the stressing direction by the bending apparatus is not necessarily parallel to the length direction (arrow X direction) or parallel to the width direction (arrow Y direction) of the blank 10, and for example, the stressing direction may contain the component in the thickness direction (arrow Z direction) of the blank 10, i.e., the stress may be applied in a direction inclined to the thickness direction.

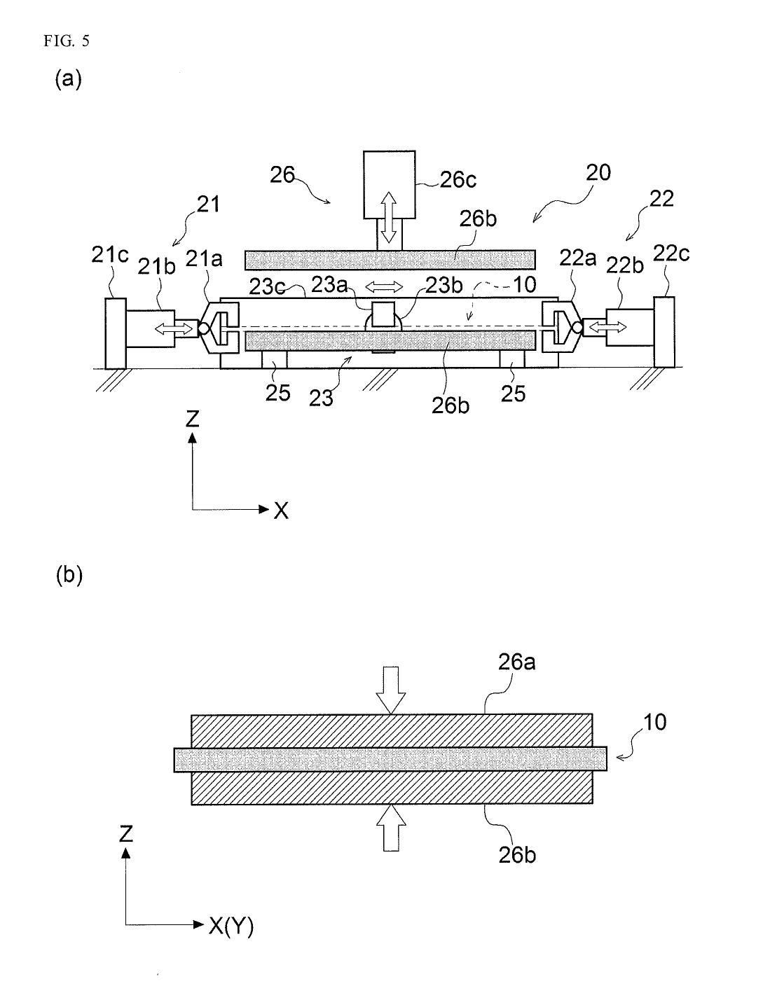

The bending apparatus 20 for the method for producing the steel sheet for press molding according to the invention further includes a cushion device 26 as shown in FIGS. 5(a) and 5(b).

As shown in FIG. 5(a), the cushion device 26 clamps and presses the blank 10 to be bent from the thickness direction (arrow Z direction), and prevents wrinkles which occur in the front 10a and back 10b of the blank 10. The cushion device includes a first cushion member 26a contacting the front 10a of the blank 10 and a second cushion member 26b contacting the back 10b of the blank.

The cushion members 26a and 26b are made by materials having adiabaticity and electric insulation (e.g., ceramic), and when the cushion members 26a and 26b contact the blank 10, the temperature of the blank 10 is prevented from lowering.

The upper cushion member 26a is supported by a shifter 26c, which can move the blank 10 arranged in the bending apparatus 20 along the thickness direction of the blank 10 (arrow Z direction).

The lower cushion member 26b is located so as to contact the back 10b of the blank 10 that is positioned in the predetermined position of the bending apparatus 20 (positioning parts 25), and to contact the positions where the wrinkles are to be prevented.

As shown in FIG. 5(b), while the cushion members 26a and 26b clamps the blank 10 in the thickness direction, and apply the stress in the direction perpendicular to the thickness direction, thereby preventing the occurrence of the wrinkles during the bending operation.

The bending apparatus 20 according to the invention further includes the cushion device 26 having the first cushion member 26a arranged along the front 10a of the blank 10 and the second cushion member 26b arranged along the back 10b of the blank 10, for reducing the wrinkles in the blank 10.

Due to the structure, the non-rectangular steel sheet for press molding 15 with high quality is obtained without occurring the wrinkles.

In the bending apparatus 20 according to the invention, the cushion members 26a and 26b are configured by the material with thermal insulation.

Due to the structure, the non-rectangular steel sheet for press molding 15 is prevented from falling in temperature during the bending operation by the bending apparatus. Therefore, the formability of the blank in the press molding can be secured.

In the embodiment, the cushion members 26a and 26b clamp and press the blank 10 in order to prevent wrinkles, however, the cushion members 26a and 26b may be apart from the blank 10 without contacting it.

More specifically, the clearance between the cushion members 26a and 26b is maintained by a predetermined distance in order to keep waving of the blank 10 during the bending operation within a predetermined height, thereby avoiding the occurrence of the wrinkles of the blank 10.

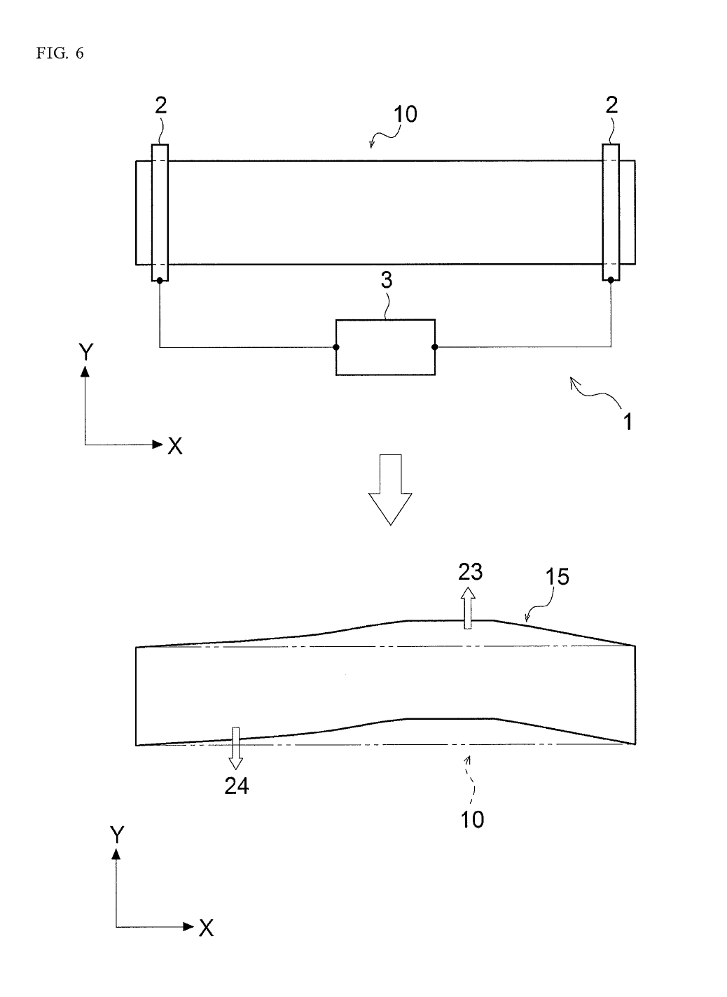

Referring to FIGS. 6 to 10, first embodiment of the method for producing the steel sheet for press molding according to the invention is described below.

As shown in FIG. 6, in the method for producing the steel sheet for press molding according to the invention, the blank 10 is heated by using the electric heating apparatus 1, after that the blank 10 is bent by using the bending apparatus 20.

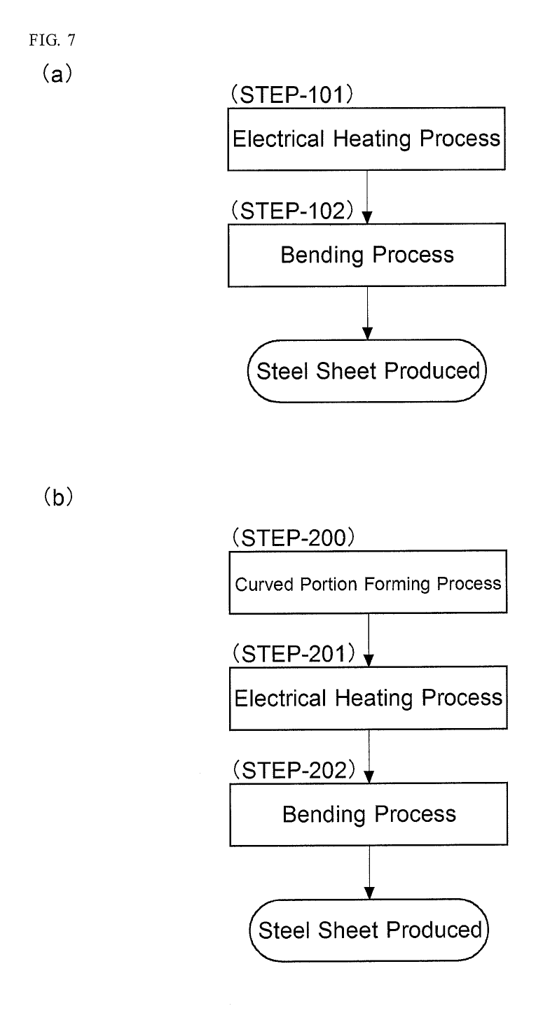

As shown in FIGS. 6 and 7(a), in the method for producing the steel sheet for press molding according to the invention, a process for electrically heating the blank 10 (hereinafter, “electrical heating process”) is performed (STEP-101).

In the electrical heating process STEP-101, the electrical heating apparatus 1 electrically heats the blank 10 having rectangle shape viewed from the thickness direction to the temperature not lower than martensitic transformation temperature (Ac3).

After that, the blank 10 is quickly transferred to next process without lowering the temperature thereof.

In the method for producing the steel sheet for press molding according to the invention, a process for bending the blank 10 that is electrically heated to the predetermined temperature (hereinafter, “bending process”) is performed (STEP-102).

In the bending process STEP-102, the bending apparatus 20 bends the blank 10 having rectangle shape viewed from the thickness direction.

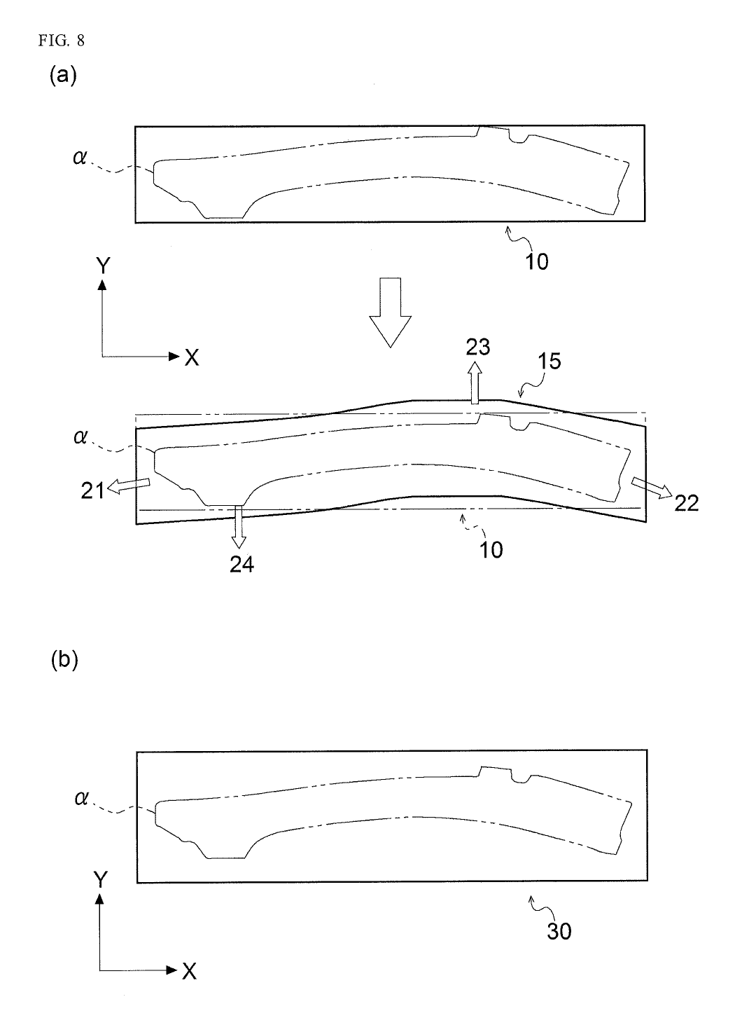

For example, FIG. 8(a) depicts a configuration of bending.

For instance, if a press-molded article to be obtained has a shape α, a blank 30 having a rectangle shape viewed from the thickness direction shown in FIG. 8(b) is used.

In the method for producing the steel sheet for press molding according to the invention, the blank 10 smaller than the blank 30 is used.

The electric heating apparatus 1 electrically heats the blank 10 smaller than the conventional blank to the predetermined temperature, and the bending apparatus 20 deforms the blank 10 into the shape corresponding to the shape α, whereby the steel sheet for press molding 15 can be formed.

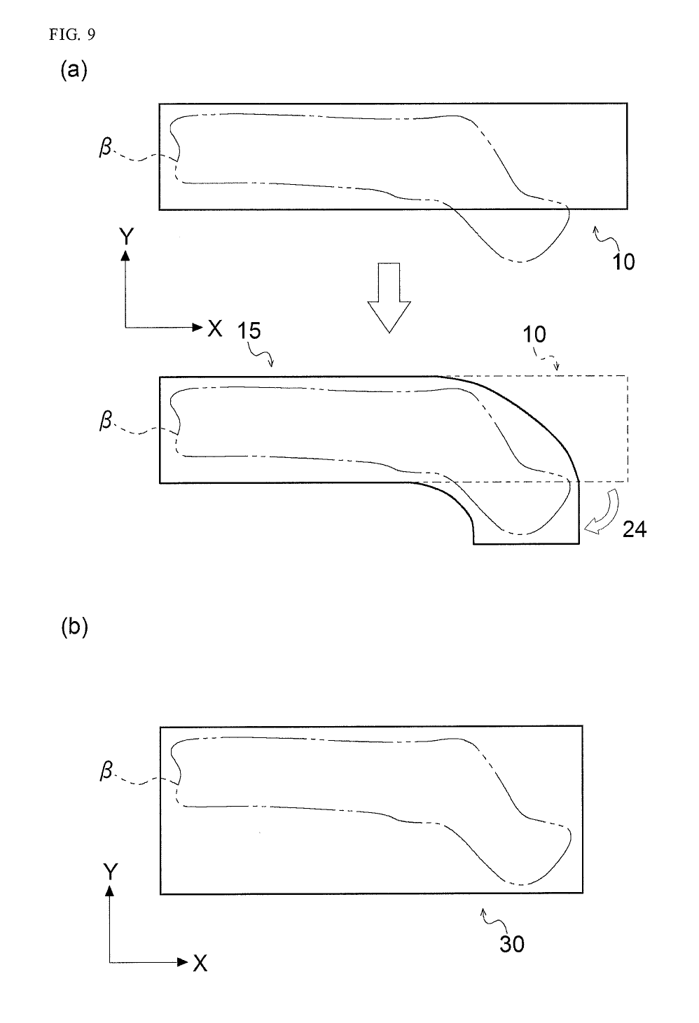

FIG. 9(a) depicts an alternative configuration of bending.

For instance, if a press-molded article to be obtained has a shape β, a blank 30 having a rectangle shape viewed from the thickness direction shown in FIG. 9(b) is used.

In the method for producing the steel sheet for press molding according to the invention, the blank 10 smaller than the blank 30 is used.

The electric heating apparatus 1 electrically heats the blank 10 smaller than the conventional blank to the predetermined temperature, and the bending apparatus 20 deforms the blank 10 into the shape corresponding to the shape β, whereby the steel sheet for press molding 15 can be formed.

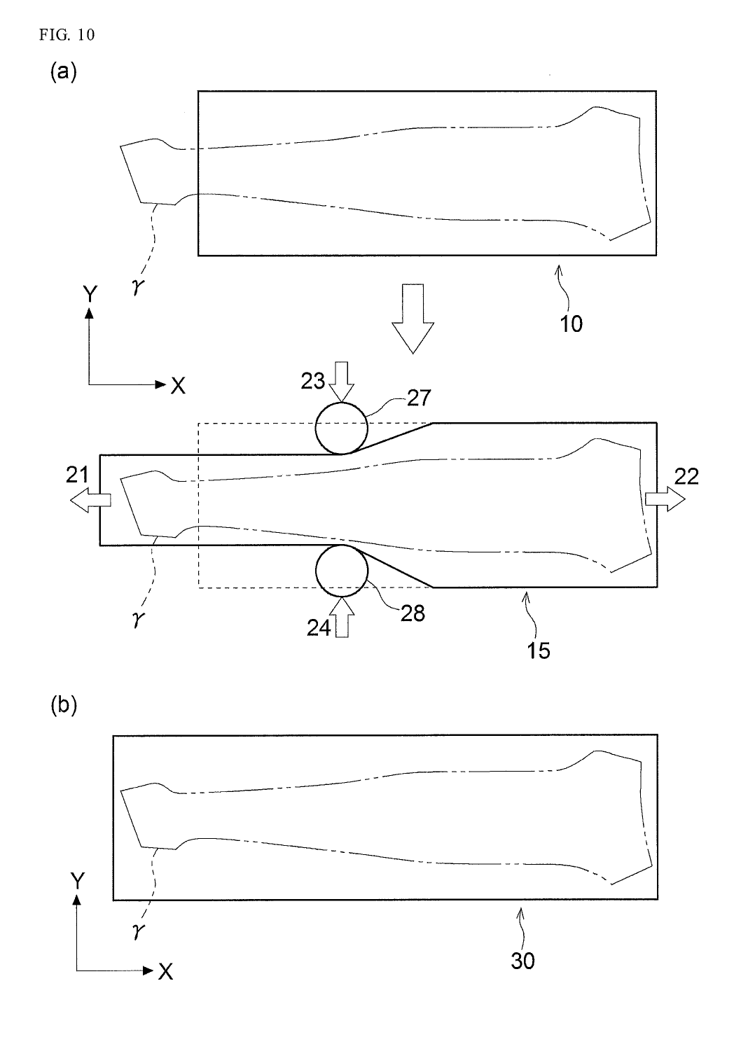

FIG. 10(a) depicts other configuration of bending.

For instance, if a press-molded article to be obtained has a shape γ, a blank 30 having a rectangle shape viewed from the thickness direction shown in FIG. 10(b) is used.

In the method for producing the steel sheet for press molding according to the invention, the blank 10 smaller than the blank 30 is used.

The electric heating apparatus 1 electrically heats the blank 10 smaller than the conventional blank to the predetermined temperature, and the bending apparatus 20 deforms the blank 10 into the shape corresponding to the shape γ, whereby the steel sheet for press molding 15 can be formed.

The method for producing the steel sheet for press molding according to the invention includes the electrical heating process (STEP-101) for electrically heating the blank 10 having the rectangle shape viewed from the thickness direction and the bending process (STEP-102) for applying the stress to the blank 10 that is electrically heated and deforming the blank form rectangular into non-rectangular.

In the method for producing the steel sheet for press molding according to the invention, the bending process (STEP-102) includes applying the stress to the blank 10 along the direction perpendicular to the thickness direction (i.e., parallel to the XY plane direction) for deformation of the blank 10 from rectangle into non-rectangle.

Due to the structure, the non-rectangular steel sheet for press molding 15 that is heated to the predetermined temperature can be obtained.

In the method for producing the steel sheet for press molding according to the invention, the process for deforming the blank 10 from rectangular into non-rectangular (i.e., the bending process (STEP-102)) includes clamping and pressing the blank 10 by using the cushion members 26a and 26b that are made of material with adiabaticity while the stress in the direction perpendicular to the thickness direction is applied to the blank 10.

Due to the structure, the non-rectangular steel sheet for press molding 15 with high quality is obtained without occurring the wrinkles.

Referring to FIGS. 7 to 11, second embodiment of the method for producing the steel sheet for press molding according to the invention is described below.

As shown in FIG. 7(b), in the method for producing the steel sheet for press molding according to the invention, a process for forming a curved portion 17a in a blank 17 (hereinafter, “curved portion forming process”) is performed (STEP-200).

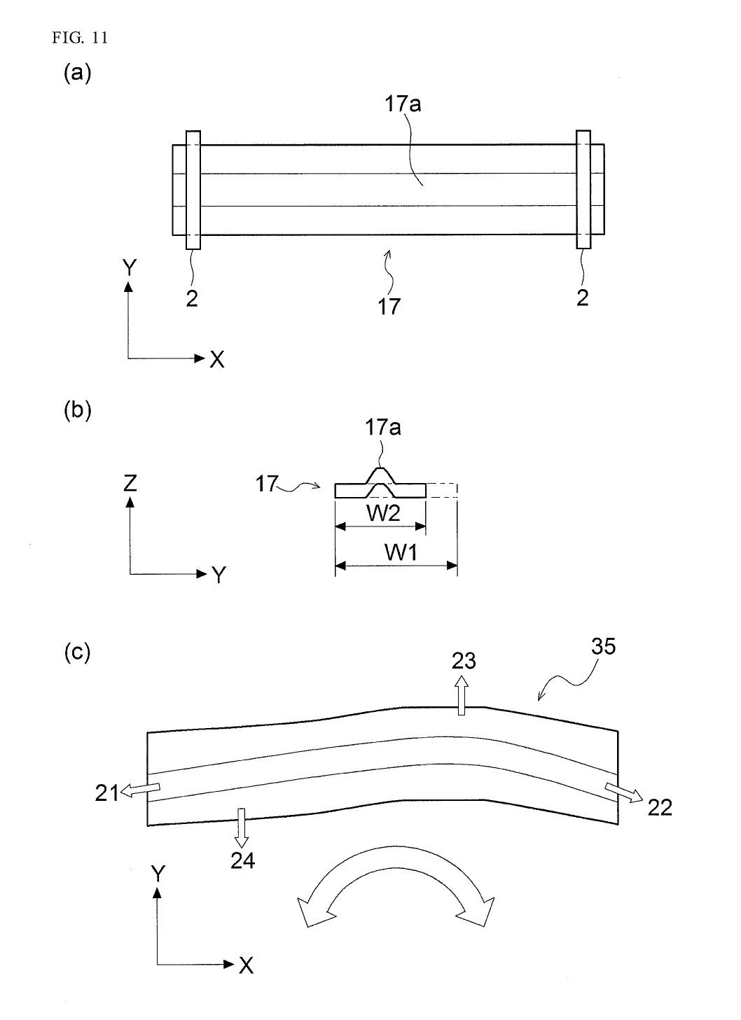

In the curved portion forming process STEP-200, a pressing apparatus (not shown) forms the curved portion 17a parallel to the length direction of the blank in the blank 17 that has width dimension W1 as shown in FIGS. 11(a) and 11(b).

Thus, the surface area of the blank 17 is maintained, and the width dimension is reduced to W2 (W1>W2).

In the second embodiment of the method for producing the steel sheet for press molding according to the invention, a electrical heating process for the blank 17 with curved portion 17a is performed (STEP-201).

In the electrical heating process STEP-201, the electrical heating apparatus 1 electrically heats the blank 17 having rectangle shape viewed from the thickness direction to the temperature not lower than martensitic transformation temperature (Ac3).

The blank 17 has the constant sectional shape along the current direction (arrow X direction), so that the electrical heating as performed to the blank 10 can be performed to the blank 17 with uniformly heated.

After that, the blank 17 is quickly transferred to next process without lowering the temperature thereof.

In the second embodiment of the method for producing the steel sheet for press molding according to the invention, a bending process for bending the blank 17 that is electrically heated to the predetermined temperature is performed (STEP-202), whereby a steel sheet for press molding 35 shown in FIG. 11(c) can be obtained.

In the bending process STEP-202, the bending apparatus 20 bends the blank 17 having rectangle shape viewed from the thickness direction.

If the bending is performed to the blank 17 in the direction perpendicular to the length direction, the stress required to the bending varies in response to the width dimension of the blank 17.

That is, the stress required to bend the blank 17 where the width dimension is W2 is smaller than that to bend the blank where the width dimension is W1.

If the stress needed to operate the bending becomes smaller, the stress applying devices 21, 22, 23 and 24 of the bending apparatus 20 can be constructed simply. In other words, the clamps 21a, 22a, 23a and 24a can be constructed simply (e.g., the thickness of the components can be thinner), or the shifters 21b, 22b, 23b and 24b can be constructed simply (e.g., the smaller hydraulic cylinders can be employed).

As described above, the second embodiment of the method for producing the steel sheet for press molding according to the invention includes the curved portion forming process STEP-200 for forming the curved portion 17a projected toward the thickness direction (arrow Z direction) in the blank 17, which is parallel to the length direction of the blank 17 (arrow X direction) before the electrical heating process STEP-201 for electrically heating the rectangular blank 17.

Due to the structure, the blank 17 can be bent by smaller stress. Therefore, the bending apparatus 20 can be constructed simply.

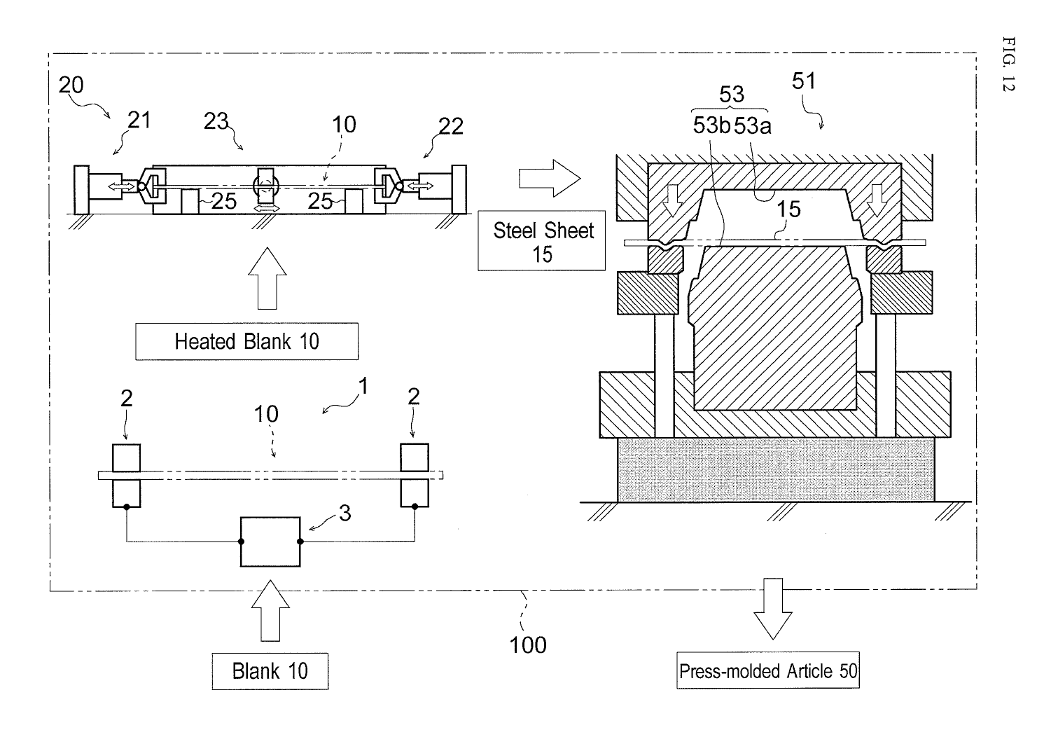

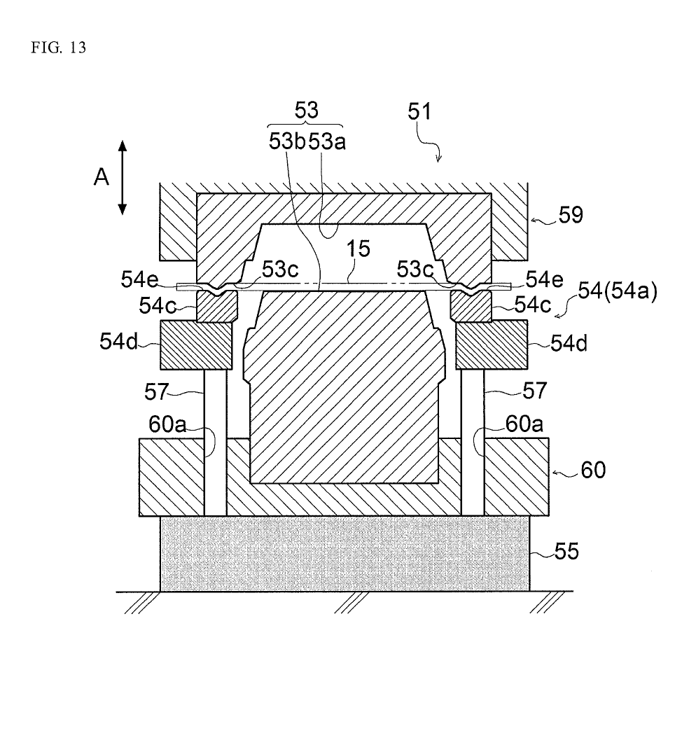

Referring to FIGS. 12 and 13, a producing apparatus for producing the press-molded article used in the producing for the press-molded article according to the invention is described below.

As shown in FIG. 12, a producing apparatus 100 for producing a press-molded article 50 according to the invention includes the electrical heating apparatus 1 for electrically heating the blank 10, the bending apparatus 20 for bending the blank 10 that is electrically heated into the steel sheet for press molding 15 and a press molding apparatus 51 for press molding the steel sheet 15 formed by the bending apparatus 20.

As depicted in FIG. 13, the press molding apparatus 51 is used for press molding the steel sheet 15 to be the press-molded article 50 into the predetermined shape, and includes a mold 53, a blank holder 54, a cushion 55, and cushion pins 57.

The mold 53 includes a die 53a as an upper mold and a punch 53b as a lower mold. The die 53a is formed with a pressing surface 53c for pressing the steel sheet 15 in cooperation with the blank holder 54.

The blank holder 54 holds the steel sheet 15 together with the die 53a.

The die 53a is fixed to a die holder 59, and the punch 53b is fixed to a punch holder 60.

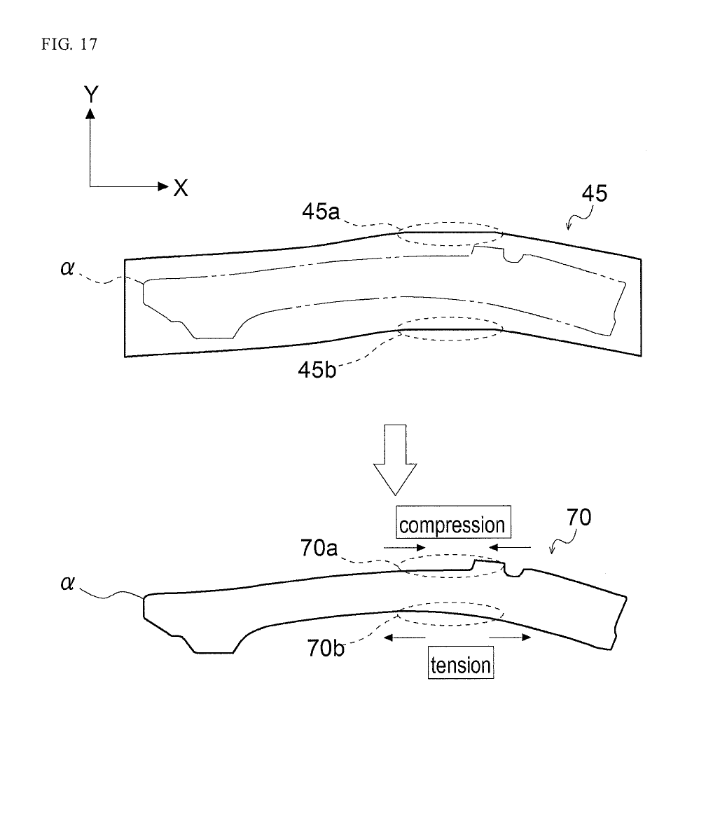

The die holder 59 is movable along the vertical direction (arrow A direction shown in FIG. 17) supported by a moving device (not shown). The punch holder 60 is formed integrally with a main frame of the press molding apparatus 51, thereby being unmovable.

Due to the structure, moving the die holder 59 in the vertical direction adjusts the distance between the die 53a fixed to the die holder 59 and the punch 53b fixed to the punch holder 60.

The punch holder 60 has holes 60a to insert the cushion pins 57.

Beneath the punch holder 60, there is arranged a cushion 55, and the bottoms of the cushion pins 57 inserted into the holes 60a contact the top of the cushion 55.

As described above, the press molding apparatus 51 included in the producing apparatus 100 for the press-molded article 50 is configured as the conventional structure which is commonly used in hot-press molding.

It should be noted that the producing apparatus 100 separately includes the electrical heating apparatus 1 for operating the electrical heating process STEP-101, the bending apparatus 20 for operating the bending process STEP-102 and the press molding apparatus 51 for press molding the steel sheet 15, however, the electrical heating apparatus 1, the bending apparatus 20 and the press molding apparatus 51 can be integrally constructed as one producing apparatus.

The producing apparatus for producing the press-molded article 50 integrally containing the electrical heating apparatus 1, the bending apparatus 20 and the press molding apparatus 51 can shorten the transfer paths from the electrical heating apparatus 1 to the bending apparatus 20 and from the bending apparatus 20 to the press molding apparatus 51, thereby reducing the temperature fall of the steel sheet 15 that is electrically heated. Therefore, the steel sheet 15 can be kept in high temperature, and the formability of that can be improved.

The bending apparatus 20 for use in the producing apparatus 100 for producing the press-molded article 50 may include the cushion devices 26 as shown in FIGS. 5(a) and 5(b).

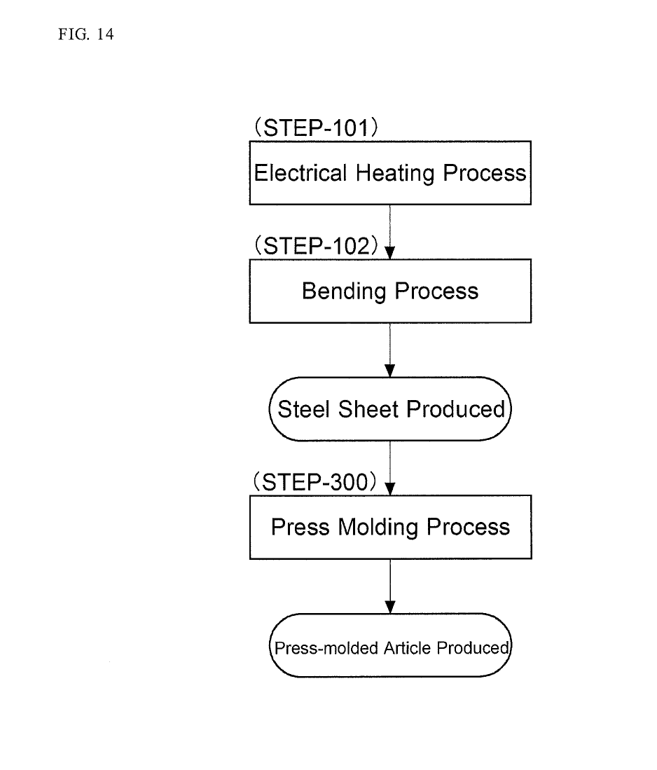

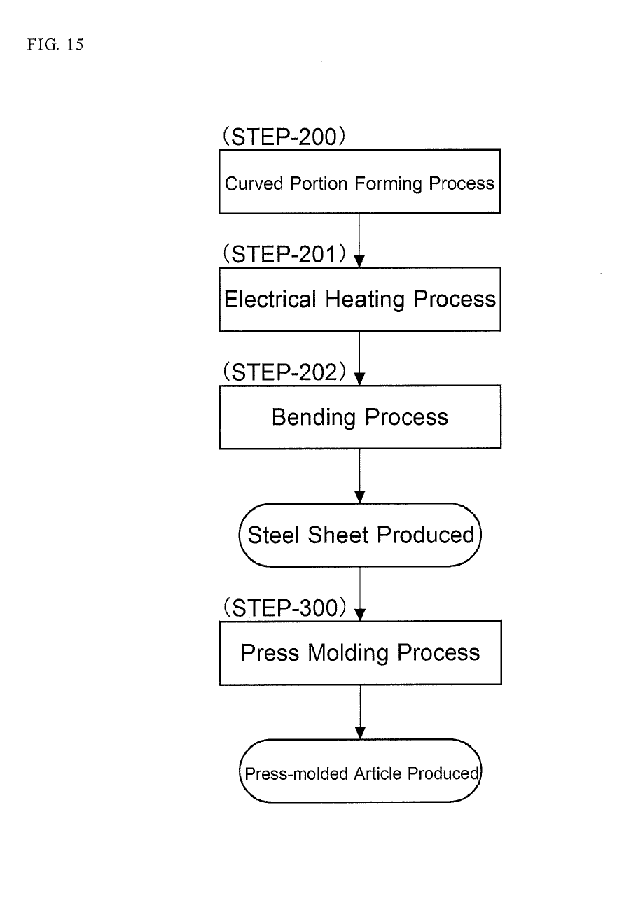

Referring to FIGS. 14 and 15, the first embodiment of the method for producing the press-molded article according to the invention is described below.

The first embodiment of the method for producing the press-molded article according to the invention uses the producing apparatus 100 (see FIG. 12) for producing the press-molded article 50, and includes, as shown in FIG. 14, the electrical heating process (STEP-101), the bending process (STEP-102) and a press molding process (STEP-300).

In the first embodiment of the method for producing the press-molded article according to the invention, the electrical heating process (STEP-101) for electrically heating the blank 10 using the electrical heating apparatus 1 (see FIG. 12) is performed.

In the first embodiment of the method for producing the press-molded article according to the invention, the bending process (STEP-102) for bending the blank 10 that is electrically heated to the predetermined temperature using the bending apparatus 20 (see FIG. 12) is performed.

The electrical heating apparatus 1 electrically heats the blank 10 having smaller shape than the conventional one to the predetermined temperature, and the bending apparatus 20 deforms the shape of the blank 10 into the shape α, thereby obtaining the steel sheet for press molding 15.

It should be noticed that, in the method for producing the press-molded article according to the invention, the bending apparatus 20 can be provided with the cushion device 26 for preventing the wrinkles of the blank 10 and producing the steel sheet 15 without wrinkles.

Moreover, the cushion members 26a and 26b of the cushion device 26 are made by materials having adiabaticity, so that the cushion device 26 is prevented from absorbing the heat from the blank, thereby producing the steel sheet 15 with avoiding the temperature fall of the blank 10.

In the first embodiment of the method for producing the press-molded article according to the invention, a process for press molding the steel sheet 15 using the press molding apparatus 51 (see FIG. 12) is performed (hereinafter, “press molding process STEP-300”).

Press-molding the steel sheet 15, the press-molded article 50 having the shape α is produced.

As described above, in the first embodiment of the method for producing the press-molded article according to the invention, the process for deforming the blank 10 from rectangular into non-rectangular (i.e., the bending process (STEP-102)) includes clamping and pressing the blank 10 by using the cushion members 26a and 26b that are made of material with adiabaticity while the stress in the direction perpendicular to the thickness direction is applied to the blank 10.

Due to the structure, the press-molded article 50 with high quality is obtained without occurring the wrinkles.

The producing process for producing the steel sheet for press molding 15 performed before the press molding process STEP-300 by means of the press molding apparatus 51 can be substituted by the second embodiment of the method for producing the steel sheet for press molding 15 according to the invention.

That is, the second embodiment of the method for producing the press-molded article according to the invention is the process for producing the press-molded article 50 by means of the producing apparatus 100 as one embodiment according to the invention (see FIG. 12), and includes, as shown in FIG. 15, the curved portion forming process STEP-200, the electrical heating process STEP-201, the bending process STEP-202, and the press molding process STEP-300.

In the second embodiment of the method for producing the press-molded article according to the invention, the curved portion forming process STEP-200 is performed to the blank 17 (see FIG. 11).

In the second embodiment of the method for producing the press-molded article according to the invention, the electrical heating process STEP-201 for the blank 17 containing the curved portion 17a is performed.

Then, press-molding the steel sheet for press molding 35 (see FIG. 11) produced by such processes, the press-molded article 50 having the shape α is produced.

As described above, the second embodiment of the method for producing the press-molded article according to the invention includes the curved portion forming process STEP-200 for forming the curved portion 17a projected toward the thickness direction (arrow Z direction) in the blank 17, which is parallel to the length direction of the blank 17 (arrow X direction) before the electrical heating process STEP-201 for electrically heating the rectangular blank 17.

Due to the structure, the blank 17 can be bent by smaller stress. Therefore, the bending apparatus 20 can be constructed simply.

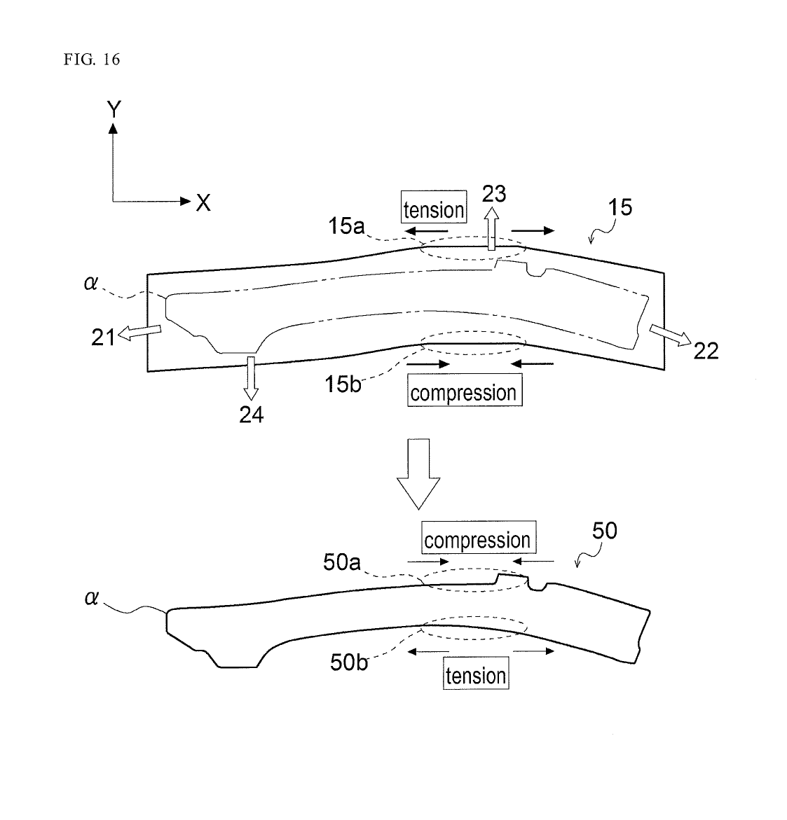

Referring to FIGS. 16 and 17, the features of the press-molded article 50 produced by press molding the steel sheet 15 are described below.

It should be noted that the following description is given to the press-molded article 50 produced by press molding the steel sheet 15, however, the press-molded article produced by press molding the steel sheet 35 having the curved portion has the same features.

As depicted in FIG. 16, in the steel sheet 15 for producing the press-molded article 50 with the shape α, that is substantially arc shape containing an outer curved portion and an inner curved portion, the thickness in the portion 15a corresponding to the outer curved portion 50a of the press-molded article 50 is reduced by tension and the thickness in the portion 15b corresponding to the inner curved portion 50b is increased by compression, after the bending process STEP-102.

The press molding process STEP-300 is performed to the steel sheet 15 having such characteristics, and the compression force in the direction perpendicular to the thickness direction is acted on the portion 15a corresponding to the outer curved portion 50a, thereby increasing the thickness, and the tensile force in the direction perpendicular to the thickness direction is acted on the portion 15b corresponding to the inner curved portion 50b, thereby reducing the thickness.

As the result of that, in the outer portion 50a of the press-molded article 50, the thickness is reduced in the bending process, and increased in the press molding process, whereby the thickness therein is substantially same as the thickness before the series of processes (the thickness of the blank 10).

In the inner portion 50b of the press-molded article 50, the thickness is increased in the bending process, and reduced in the press molding process, whereby the thickness therein is substantially same as the thickness before the series of processes (the thickness of the blank 10).

As described above, in the press-molded article 50 produced by the method for producing the press-molded article according to the invention, the thicknesses in the outer curved portion 50a and the inner curved portion 50b are substantially same.

On the other hand, as shown in FIG. 17, in a steel sheet for press molding 45 produced by a conventional producing method such as punching, the portion 45a corresponding to the outer curved portion 70a of the conventional press-molded article 70 and the portion 45b corresponding to the inner curved portion 70b have the same thickness.

Thus, in the conventional press-molded article 70 produced by press molding the steel sheet 45, the thickness in the outer curved portion 70a is larger than the thickness of the inner curved portion 70b.

In the conventional press-molded article 70, the thickness in the inner curved portion 70a where the thickness is comparatively thin is set as a standard to secure a required rigidity, and the thickness of the blank is determined considering the thickness in the inner curved portion 70a. Thus, in the conventional art, the thickness of the blank is set larger than the final thickness (after press molding) of the inner curved portion 70a.

In the press-molded article 50 produced by the producing method according to the invention, the thicknesses in the outer curved portion 50a and in the inner curved portion 50b are the same, so that the thickness of the blank 10 can be thinner than the conventional blank.

It should be noticed that the articles containing such outer curved portion and inner curved portion are, for example, the A pillar and the roof side rail composing the vehicle body and the chassis frame and the side rail composing the vehicle chassis.

As described above, the first embodiment of the method for producing the press-molded article according to the invention includes the electrical heating process (STEP-101) for electrically heating the blank 10 having the rectangle shape viewed from the thickness direction, the bending process (STEP-102) for applying the stress to the blank 10 that is electrically heated and deforming the blank form rectangular into non-rectangular, and the press molding process (STEP-300) for press molding the steel sheet for press molding 15 as the non-rectangular blank 10 to which the stress is applied by means of the bending apparatus 20.

The embodiment of the producing apparatus 100 for the press-molded article 50 according to the invention includes the electrical heating apparatus 1 for electrically heating the blank 10 having the rectangle shape viewed from the thickness direction, the bending apparatus 20 for applying the stress in the direction perpendicular to the thickness direction, and the press molding apparatus 51 for press molding the steel sheet for press molding 15 as the non-rectangular blank 10 to which the stress is applied by means of the bending apparatus 20.

Due to the structure, the press-molded article 50 having the uniform thicknesses in the outer curved portion 50a and in the inner curved portion 50b can be produced.

### INDUSTRIAL APPLICABILITY

The method for producing the steel sheet for press molding, and the method and apparatus for producing the press-molded article according to the present invention are applicable not only to produce a press-molded article used as a vehicle part but also to a producing field in which the press-molded article is produced by press molding.

1. A method for producing a steel sheet for press molding comprising:
an electrical heating process for electrically heating a steel blank having a rectangle shape viewed from a thickness direction of the steel blank; and
a deforming process for deforming the steel blank from the rectangle into a non-rectangle by applying a stress to the steel blank after the start of electrical heating.

2. The method according to claim 1, wherein
in the deforming process, the stress is applied in a direction perpendicular to the thickness direction of the steel blank to the steel blank after the electrical heating.

3. The method according to claim 2, wherein
in the deforming process, the stress is applied in a direction perpendicular to the thickness direction of the steel blank to the steel blank with clamping and pressing the steel blank by means of cushion members made by materials having adiabaticity.

4. The method according to claim 1, further comprising:
a curved portion forming process for forming a curved portion projected toward the thickness direction in the steel blank, which is parallel to a length direction of the steel blank before the electrical heating process.

5. A method for producing a press-molded article, comprising:
an electrical heating process for electrically heating a steel blank having a rectangle shape viewed from a thickness direction of the blank;
a deforming process for deforming the steel blank from the rectangle into a non-rectangle by applying a stress to the steel blank after the start of electrical heating; and
a press molding process for press molding the steel blank having the non-rectangle shape to which the stress is applied.

6. The method according to claim 5, wherein
in the deforming process, the stress is applied in a direction perpendicular to the thickness direction of the steel blank to the steel blank with clamping and pressing the steel blank by means of cushion members made by materials having adiabaticity.

7. The method according to claim 5, further comprising:
a curved portion forming process for forming a curved portion projected toward the thickness direction in the steel blank, which is parallel to a length direction of the steel blank before the electrical heating process.

8. An apparatus for producing a press-molded article, comprising:
an electrical heating apparatus for electrically heating a steel blank having a rectangle shape viewed from a thickness direction of the steel blank;
a stress applying device for applying a stress in a direction perpendicular to the thickness direction of the steel blank to the steel blank after the start of electrical heating; and
a press molding apparatus for press molding the steel blank having a non-rectangle shape to which the stress is applied by the stress applying apparatus.
